(19) United States
(12) Patent Application Publication
(10) Pub. No.: US 2002/0107835 A1
(43) Pub. Date: Aug. 8, 2002

(54) System and method for adaptive result set caching

(76) Inventors: Michael T. Coram, Ashburn, VA (US); Vijayakumar Perincherry, Gaithersburg, MD (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/024,522

(22) Filed: Dec. 21, 2001

Related U.S. Application Data
(63) Continuation-in-part of application No. 09/778,716, filed on Feb. 8, 2001.

(51) Int. Cl. G06F 7/00

(52) U.S. Cl. 707/1

(57) ABSTRACT

Methods and systems are described according to the present invention for result set caching that include receiving an informational database request and determining whether a result set corresponding to the informational database request is stored in a cache. If the result set is stored in the cache, the result set is returned in response to the informational database request. If the result set is not stored in the cache, then the informational database request is sent to a database for processing. A determination is then made whether to add the result set to the cache, where the determination is based at least in part on the cache-worthiness of the result set. According to another aspect of the present invention, a desired level of data freshness is achieved by determining whether a database request is transactional, and if so, invalidating those result sets stored in the cache that include data targeted by the transactional database request. The cache might also invalidated result sets on a timed basis to account for transactional database requests that do not pass through the cache.

### CROSS REFERENCE TO RELATED APPLICATIONS

This application claims priority to co-pending U.S. patent application No. 09/778,716, entitled “System and Method for Adaptive Data Caching,” filed on Feb. 8, 2001, the entirety of which is incorporated herein by reference.

### BACKGROUND

1. Field of the Invention

The present invention relates generally to electronic databases and more particularly to a system and method for adaptively caching result sets.

2. Discussion of the Related Art

Many computer applications today utilize a database to store, retrieve, and manipulate information. Simply put, a database refers to a collection of information organized in such a way that a computer program can quickly select desired pieces of data. For example, an individual might use a database to store contact information from their rolodex, such as names, addresses, and phone numbers, whereas a business entity might store information tracking inventory or customer orders.

Databases include the hardware that physically stores the data, and the software that utilizes the hardware's file system to store the data and provide a standardized method for storing, retrieving or changing the data. A database management system (DBMS) provides access to information in a database. This is a collection of programs that enables a user to enter, organize, and select data in a database. The DBMS accepts requests for data (referred to herein as database requests) from an application program and instructs the operating system to transfer the appropriate data. Database requests can include, for example, read-only requests for database information (referred to herein as informational database requests) and request to modify database information (referred to herein as transactional database requests). With respect to hardware, database machines are often specially designed computers that store the actual databases and run the DBMS and related software.

In a conventional database configuration, a computer application accesses stored information by issuing database requests to the DBMS. The DBMS processes the request by, for example, modifying data in the database and/or returning requested data to the computer application. Oftentimes, the computer application issues database requests to the DBMS via a network, such as the Internet, other wide area networks, or a local area network.

The performance of the conventional database configuration can be improved with the addition of a cache. The cache can be inserted, for example, between the application and the database. This is referred to herein as an inline cache configuration. Database requests from the application are directed first to the cache. The cache provides rapid access to a subset of the information stored in the database. The cache processes the requests whenever possible which reduces the processing demands on the database.

The cache might handle requests differently depending on the type of operation requested and whether the target data is stored in the cache. For example, informational database requests can be handled by the cache without going to the database, so long as the information that is the target of the request (i.e., the target data) in stored in the cache. Since the response time of the cache is significantly faster than that of the database, performance is increased as the percentage of information database requests grows in relation to the total number of database requests. Transactional database requests, on the other hand, should be processed in the database. The cache may also process the request or could update its contents via another mechanism.

Information stored in the database (and the cache) can be broken down into various components that are collectively referred to herein as objects (or database objects). Objects can be inter-connected or independent, and will vary in functionality and hierarchy. Example objects in a relational database include tables, columns (or fields), records, cells, and constraints. Another example object is a result set. As used herein, a result set refers to the data resulting from the execution of an informational database request and its associated metadata. For example, if an informational database request asks for the name and address of all employees, the result set would contain an ordered set of names and addresses as well as metadata such as column names and sizes. In a relational database, where data is stored in the form of tables, objects can refer to both the tables themselves as well as a result set that includes data extracted from one or more tables.

A cache can be configured to store any of these types of objects. For example, one or more tables from the database can be stored in the cache. Informational database requests can be processed at the cache so long as the target data is included within the tables stored locally. The cache processes these requests and extracts the target data, in the same manner that the request would be processed at the database. In the above example, the cache extracts the requested names and addresses from tables stored in the cache. This request can be fully satisfied so long as all of the relevant tables are stored in the cache.

The cache can alternatively be configured to store result sets. This configuration is referred to herein as a result set cache. For example, the result set generated by processing the above example request at the database might be stored in the cache. Subsequent requests for the same information might be satisfied by returning the stored result set. Result set caching has the significant advantage of obviating the need to process those requests for which a valid result set is already available.

However, there are also significant difficulties associated with result set caching. First, it is impractical in most cases to cache all of the possible result sets that an application might request. This might be because the result sets are large relative to the storage capacity of the cache, or because the application can issue a large number of different requests. The cache should therefore apply some criteria for caching some result sets and discarding others. One conventional approach is to employ a least recently used (LRU) algorithm, where the most stale result set (i.e., the result set that has gone the longest without being used) is dropped when the cache reaches maximum capacity. The least frequently used (LFU) algorithm is another conventional approach, where the result set used the least frequently is discarded. LFU requires that usage frequencies be kept whereas LRU can be implemented with a simple timestamp.

Data consistency can also be an issue for many applications. Consistency is not a problem where the application accesses static data. Once generated, the result set will remain valid so long as the underlying data doesn't change. However, in dynamic environments, result sets generated at one point in time will become invalid once the underlying data changes. The degree to which invalid result sets will be tolerated can vary according to the application. For example, an online shopping site might show approximate inventory levels on pages which customers are browsing. On such pages, having data which is minutes or even hours old is acceptable. However, when the customer checks out, the order fulfillment process will clearly need up-to-date information. The result set cache should therefore be capable of updating its contents to achieve the desired level of data freshness.

Improved techniques for result set caching are therefore needed that more effectively select result sets for storage in the cache, and that provide a desired level of data freshness.

### SUMMARY OF THE INVENTION

The present invention addresses these needs by providing a method and system for result set caching that includes receiving an informational database request and determining whether a result set corresponding to the informational database request is stored in a cache. If the result set is stored in the cache, the result set is returned in response to the informational database request. If the result set is not stored in the cache, then the informational database request is sent to a database for processing. A determination is then made whether to add the result set to the cache, where the determination is based at least in part on the cache-worthiness of the result set.

According to another aspect of the present invention, a desired level of data freshness is achieved by determining whether a database request is transactional, and if so, invalidating those result sets stored in the cache that include data targeted by the transactional database request. The cache might also invalidate result sets on a timed basis to account for transactional database requests that do not pass through the cache.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts an example computing environment wherein an application issues database requests to access data stored in an inline result set cache and a database.

FIG. 2 depicts a flowchart that describes the general operation of a result set cache according to an example embodiment of the present invention.

FIG. 3 depicts several processes that are employed by a result set cache in addition to or in conjunction with the general operations described above with respect to FIG. 2.

FIG. 4 is a flowchart that describes a technique for invalidating result sets according to an example embodiment of the present invention.

FIG. 5 depicts a client-side implementation of a result set cache according to an example embodiment of the present invention.

FIG. 6 depicts a server-side implementation of a result set cache according to an example embodiment of the present invention.

FIG. 7 depicts a result set cache implemented as a stand-alone appliance according to an example embodiment of the present invention.

### DETAILED DESCRIPTION

Techniques according to the present invention are described herein for result set caching. Result sets are selected for caching based on their cache-worthiness. A variety of data can be collected and relied upon to establish the cache-worthiness of a result set, such as the number of requests for a particular result set, or the number of times a result set has been invalidated due to changes in the underlying data. The overall effectiveness of a result set caching scheme can thereby be improved by caching those result sets deemed to be the most worthy of caching. Furthermore, techniques are described for achieving a desired level of freshness in the result set cache. Result sets are invalidated whenever the cache receives a transactional request that modifies the underlying data from which the result set was generated. Modifications which are not received by the cache can also invalidate result sets in the cache, so the result set cache must also have a mechanism to handle such invalidations.

These techniques are implemented according to the present invention without any application level involvement. The existence of the result set cache is hidden behind standard programming APIs, so that the operation of the cache is invisible to the application. As a result, application developers need not be concerned with modifying the application logic to achieve effective result set caching.

The present invention includes one or more computer programs which embody the functions described herein and illustrated in the appended flowcharts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flowcharts and associated written description included herein. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Overview

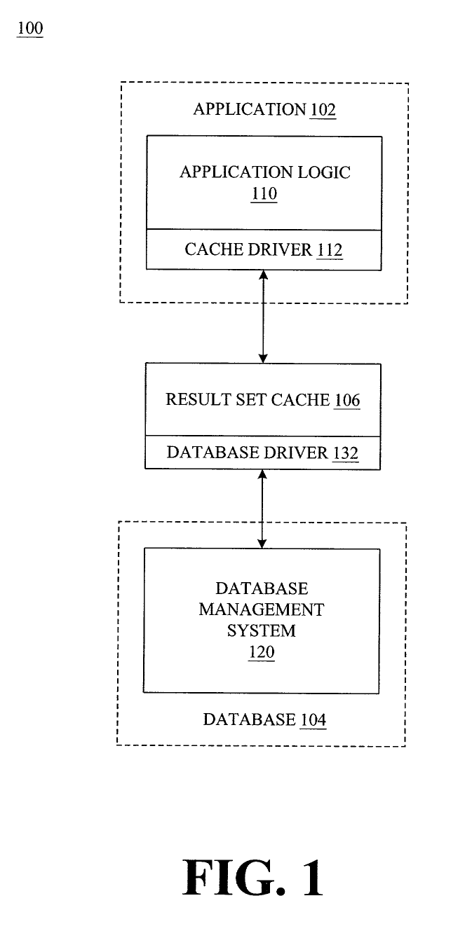

FIG. 1 depicts an example computing environment 100 wherein an application 102 accesses data stored in a database 104 that includes a DBMS 120. A result set (RS) cache 106 is inserted between application 102 and database 104. Database requests issued by application 102 are sent first to RS cache 106 for processing. Application 102 includes application logic 110 and a cache driver 112. Cache driver 112 provides an application programming interface (API) that application logic 110 uses when interacting with RS cache 106. Similarly, a database driver 132 provides an API that RS cache 106 uses when interacting with database 104.

Database 104 represents a database system including the computer hardware and software necessary for storing, retrieving, modifying and otherwise manipulating database information. Database 104 includes a DBMS 120. Result set cache 106 communicates with DBMS 120 using database driver 132. Database 104 can represent one or more servers that store the actual databases and run DBMS 120 and related software.

Database 104 stores a collection of related data. For example, database 104 might store database information as relational data based on the well known principles of Relational Database Theory wherein data is stored in the form of related tables. Many database products in use today work with relational data, such as products from INGRES, Oracle, Sybase, and Microsoft. Other alternative embodiments can employ different data models, such as object or object relational data models. A result set in an XML/XQL based database might be a document fragment or something similar. In object-oriented databases (OODBs), result sets are typically a collection of objects.

Application 102 can represent any computer application that accesses database 104, such as a contact manager, order tracking software, or any application executing on an application server connected to the Internet. Application logic 110 represents the portion of application 102 devoted to implementing the application functionality. This could be a standalone application or an application or web server with additional tiers in front (such as a web browser or other client interface). Application 102, RS cache 106, and database 104 operate according to an n-tiered architecture. Application 102 is a client to RS cache 106, which acts as a server to Application 102. RS cache 106 is also a client to database 104, which acts as a server.

RS cache 106 represents the computer hardware and software necessary to implement the result set caching techniques described herein. For example, RS cache 106 can be implemented as a high performance computer application running on a dedicated machine. RS cache 106 can also be implemented using client- or server-side resources rather than as a dedicated machine. For example, RS cache 106 can share computing resources with the client system that hosts application 102. Alternatively, RS cache 106 can be implemented within database 104. These various alternative embodiments of the present invention are described in greater detail below. These example embodiments are not mutually exclusive—they may be used in combination with one another. Multiple RS cache 106 instances running on dedicated machines may also exist in a tiered or clustered manner.

RS cache 106 stores one or more result sets. A result set is created when a database request is processed at database 104, where the requested data forming the result set is extracted from objects stored in database 104. Techniques for selecting result sets for caching are described in detail below. For those result sets that are selected for caching, storing a key based in part or in whole on the associated database request along with the result set is used to determine whether subsequent requests can be satisfied by the cached result set. Additional data associated with each result set, such as request parameters and result set metadata, can also be stored in RS cache 106. This metadata can include, for example, column names and sizes as well as an indication of the objects (e.g., tables) stored in database 104 from which the result set was generated (the underlying data).

Cache driver 112 provides an interface between application logic 110 and RS cache 106. For example, application logic 110 calls functions defined in cache driver 112 to issue database requests that are then serviced by RS cache 106 and/or database 104. Similarly, database driver 132 provides an interface between RS cache 106 and DBMS 120. Both of these drivers could support conventional database standards, such as, for example, the Open Database Connectivity (ODBC) and Java Database Connectivity (JDBC) standards, or they could utilize proprietary APIs such as Oracle's OCI. In relational databases, clients using these types of drivers can generate Structured Query Language (SQL) query requests for the server to process. As will be apparent, other types of drivers employing alternative query languages can also be used within the scope of the present invention. For example, RS cache 106 also supports the ability to respond to Extensible Markup Language Query Language (XQL) queries against XML databases, Object Query Language (OQL) queries against object-oriented databases, or any other query language, using an appropriate driver for that technology.

Various techniques for result set caching are described herein. Generally speaking, result set caching is accomplished by storing the results of a database request and returning those results in response to subsequent requests for the same result set. Result set caching is most effective when result sets are requested repeatedly and the underlying data does not change often. Cache performance will degrade to the extent that these conditions are not met. For example, the performance improvement resulting from caching result sets that are requested only infrequently might be outweighed by the overhead costs associated with maintaining the cached result set. The net effect might therefore be to degrade overall system performance. Similarly, if the underlying data changes often, then the result sets in the case will become stale in shorter periods of time. Maintaining data freshness also has an associated overhead, which can result in a net decrease in performance. Techniques according to the present invention seek to take these factors into account when selecting result sets to cache.

General Operation

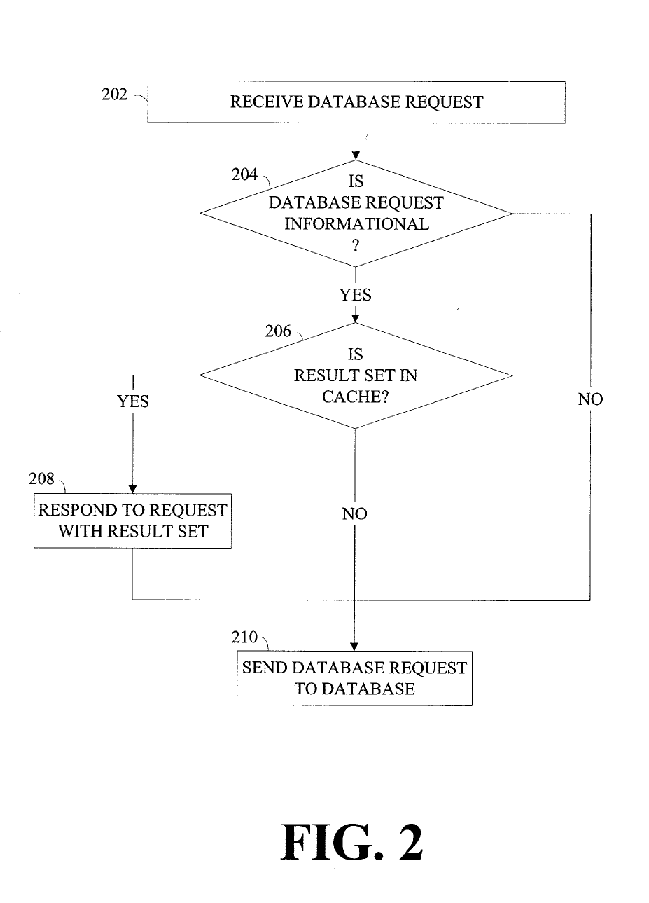

FIG. 2 depicts a flowchart 200 that describes according to an example embodiment of the present invention the general operation of RS cache 106 when processing database requests from application 102. In operation 202, RS cache 106 receives a database request from application 102. Application logic 110 issues the database request by calling the appropriate function (or functions) specified in cache driver 112.

In operation 204, a determination is made as to whether the database request is informational, and therefore qualified to be processed by RS cache 106. As will be apparent, various techniques can be used to determine whether a database request is informational (or transactional). These techniques can vary according to the particular language used to query the database. For example, in SQL implementations, “SELECT” database requests are determined to be informational and therefore potential candidates for cache processing. Different techniques might be appropriate for other database query languages.

If the database request is determined not to be informational, then in operation 210 the request is sent to database 104 for processing. If the database request is determined to be informational, then in operation 206 a determination is made as to whether the result set requested by the received database request (referred to herein as the target result set) is stored in RS cache 106. This determination can be made by comparing the received database request to the request associated with each result set saved in RS cache 106.

A relatively simple approach to making this determination is to require that the saved request be identical to the received request—for example, requiring that the SQL strings match. If an identical request is found, then RS cache 106 determines that the target result set is stored in the cache. This approach has the advantages of being fast, easy to implement, and requiring minimal processing. However, care should be taken if exact string matching in database requests is utilized. Most query languages allow for parts of the request to be specified at runtime through the binding of parameters. If the results of these requests were candidates for caching, it would be necessary to check not only the query string but also the values of the parameters to ensure that the informational database request is indeed identical. For example, in SQL, the query “select ※ from employee where empid =?” is a parameterized query. The ? is replaced by the database before execution with a parameter specified by the client. Clearly, different result sets would be returned if different empid's were used. Thus, if parameterized queries were allowed, the result set cache would need to ensure that the parameters were equal as well as the query strings. In many cases, it may be easier to eliminate parameterized database requests from the cache. It is likely that many different values for the parameters will be used, reducing the frequency of which matching database requests are issued.

A more sophisticated determination can also be made in operation 206, to identify those requests that, though not identical, still target identical result sets. This can occur where two requests are logically the same, but literally different. For example, capitalization differences in keywords might not create a logical difference but does create a literal difference. Other more complex cases could also be considered. For example, in SQL the order of conditionals separated by AND in a WHERE clause is irrelevant (that is, “select ※ from tableA where a=1 and b=2” is equivalent to “select ※ from TableA where b=2 and a=1”). Requests that are logically identical can be satisfied by the same result set. Whether the costs associated with the additional parsing and comparison logic required to make this determination are outweighed by the benefit of identifying the cache hits can vary depending upon the particular application.

If the target result set is determined to be stored in RS cache 106, then in operation 208 the target result set is returned to application 102 in response to the received request. If the target result set is determined not to be stored in RS cache 106, then in operation 210 the received database request is sent to database 104 for processing.

Database 104 processes those database requests forwarded by RS cache 106. Result sets generated for informational database requests are returned to RS cache 106, which then returns the result set to application 102 in response to the request. RS cache 106 might or might not cache the result set. According to the present invention, this determination is made on the basis of the cache-worthiness of the result set. Techniques for making this determination are described below. But first, the following section describes techniques for maintaining the freshness of the result sets stored in RS cache 106.

Techniques for Maintaining Cache Freshness

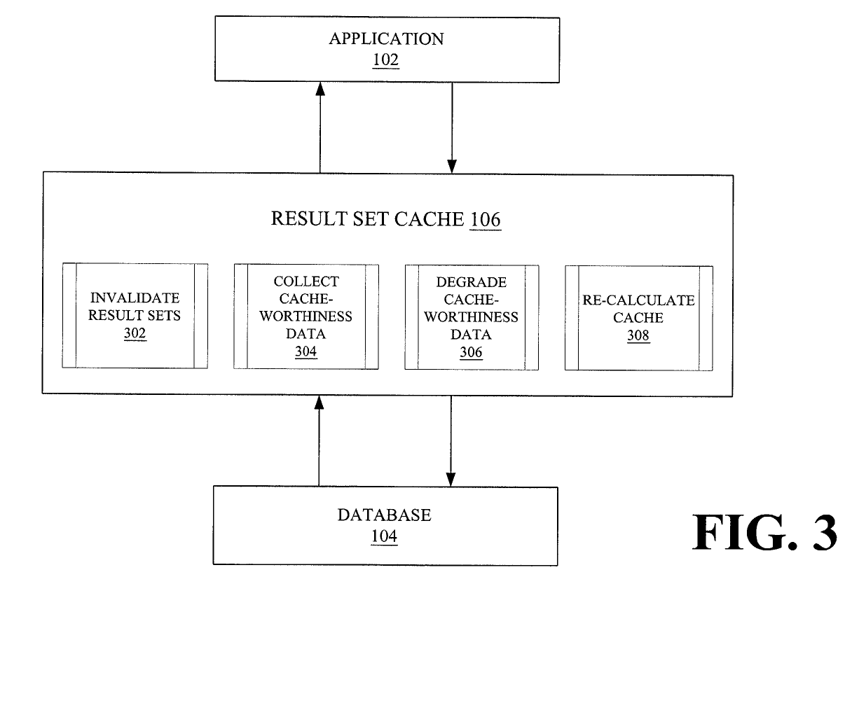

FIG. 3 depicts several processes that are employed by RS cache 106, in addition to or in conjunction with the general operations described above with respect to FIG. 2. The first of these processes, INVALIDATE RESULT SETS 302, is directed to maintaining a desired level of freshness of the result sets stored in RS cache 106. RS cache 106 can employ various techniques for determining when a particular result set will no longer considered to be valid. Once a result set is no longer considered valid, RS cache 106 invalidates the result set so that it will no longer be considered as a possible response to database requests received subsequent to the invalidation. Invalid result sets can be removed from memory immediately or simply replaced in cache memory by one or more valid result sets as they become available.

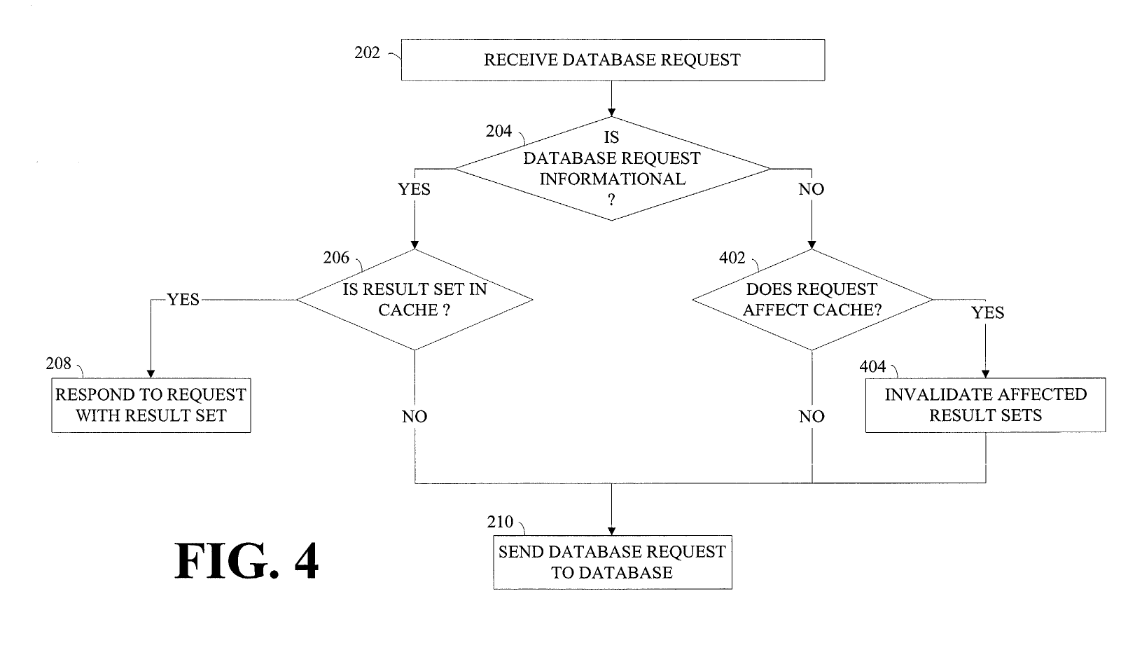

FIG. 4 is a flowchart that describes a technique for invalidating result sets according to an example embodiment of the present invention. Upon receiving a database request in operation 202 and determining that the request is not informational in operation 204, a determination is made in operation 402 as to whether the received database request will potentially affect the data underlying one or more of the result sets stored in RS cache 106. Any result sets determined to be potentially affected by the request are invalidated in operation 404. As a result, subsequent requests for the invalidated result sets will be processed by database 104, and will therefore correctly reflect the updated data.

Any transactional database request can be parsed or otherwise interrogated to determine what database objects it affects and therefore what result sets are potentially invalidated by it. In a result set cache for relational data, it is possible to simply parse the SQL and determine the tables involved and invalidate any result sets which use any of those tables in any manner. Affected result sets can be determined by comparing the affected database objects with the metadata stored along with each result set stored in the cache indicating the objects underlying the result set.

Because not all database requests might pass through a given RS cache 106, additional mechanisms for maintaining cache freshness are used in conjunction with the operations of FIG. 4. According to an example technique, result sets stored in RS cache 106 might be invalidated after some period of time. This is relatively simple to implement and does not require a synchronization protocol between multiple RS caches 106 servicing a single database 104. However, this time-out technique is imprecise in the sense that result sets might be invalidated even though their underlying data has not changed. And conversely, result sets might be considered fresh because they have not timed-out even though their underlying data has changed.

This additional invalidation technique might be appropriate where modifications are made to the data stored in database 104 as the result of database requests that do not pass through any RS cache 106. RS cache 106 would otherwise be unaware of these data modifications absent some notification from database 104, which is another technique to ensure cache freshness. If database 104, via triggers, transaction logs, or some other mechanism, were to provide notification of updates to RS cache 106, the cache could use this information to handle invalidations. In such a case, there would be less of a need to interrogate transactional database requests, depending on how quickly notification of the change were received.

A third option is available whenever all transactional database requests pass through one of the RS caches 106. In this case, RS cache 106 instances can communicate with each other to keep their contents in synchronization with database 104. As will be apparent, a combination of these techniques could be employed.

Selecting Result Sets For Caching Based on Cache-Worthiness

Returning now to FIG. 3, RS cache 106 employs several processes related to maintaining the cache population of result sets on the basis of their cache-worthiness: collecting cache-worthiness data 304, updating the cache 306, and degrading cache-worthiness data 308. As with the invalidating result sets process 308, these three processes can be employed in addition to or in conjunction with each other and with the general operations described above with respect to FIG. 2.

Generally speaking, the cache-worthiness of an object as used herein refers to a measure of confidence in the belief that the result set should be cached. Cache-worthiness data can be collected that supports or rejects this belief. This data is used to update cache-worthiness values over time for each result set, so that the cache contents can be adapted to reflect the changing cache-worthiness of the stored result sets. The cache population at any given time should therefore reflect those result sets currently deemed to be the most cache-worthy. The concepts of object cache-worthiness and the collection of various types of cache-worthiness data are described in detail in co-pending U.S. patent application No. 09/778,716, entitled “System and Method for Adaptive Data Caching,” which is incorporated by reference above.

As described above with respect to FIGS. 1 and 2, all database requests issued by application 102 for data stored in database 104 are first sent to RS cache 106. This allows RS cache 106 to monitor all requests originating from the client application, and to collect cache-worthiness data related to these requests.

As applied to result set caching, various types of cache-worthiness data can be collected in process 304. Examples of such data include, but are not limited to, the number of times a particular result set satisfies a received database request, the size of the result set, and the amount of time it takes database 104 to process the request and return the result set to RS cache 106. All of these factors can be considered when determining the cache-worthiness of a particular result set. Generally speaking, the most cache-worthy result sets are those that are relatively small, frequently requested, take a relatively long time to be executed and fetched, and are based on underlying data that changes relatively infrequently. Aggregations are good examples of result sets that can take a significant amount of time to generate and yet still return relatively small amounts of data. Frequently requested aggregations of slowly varying data are therefore considered to be highly cache-worthy result sets.

RS cache 106 is capable of measuring these various types of cache-worthiness data. For example, RS cache 106 is aware of result set size and the number of times the result set is requested by application 102. RS cache 106 can also measure the time required for a result set to be processed and fetched from database 104. This time should be adjusted to include only the elapsed time from issuance of the database request by cache driver 112 to receipt of the result set at RS cache 106 from database 104, excluding any delay resulting from application 102.

RS cache 106 can also keep track of the number of times a result set has been invalidated. As discussed above, a result set can be invalidated as the result of requests received from application 102 that cause a change to the data underlying the result set. This approach, however, does not detect invalidations which do not go through the result set cache. The timed flushing of the cache, as described above, need not be counted as an invalidation in this context since the underlying data might not have changed. However, notifications of invalidations sent from other RS cache 106 instances or from database 104 can be taken into account.

The various counts maintained by process 304, such as the number of times a result set is requested or invalidated, are degraded in process 306 to ensure that the contents of the cache represent the current usage patterns as closely as possible. Degradation can occur, for example, either on a fixed interval or whenever a cache miss occurs. A cache miss occurs whenever a database request is determined to be qualified for caching, but the requested result set is determined not to be stored in RS cache 106. Basing the degradation process 306 on cache misses has the advantage of more rapidly adjusting cache-worthiness values to reflect fast changing request patterns.

The following formula can be used to degrade any of the counts:

count=count−(coeff※count※((maxValue(count)−count)/maxValue(count))

Where coeff is a value between 0 and 1. The greater the value of coeff, the faster degradation will occur. The smaller the value, the slower degradation will occur. This coefficient should be determined empirically, but current testing suggests that approximately 0.1 produces satisfactory results.

Cache-worthiness data indicating average time to execute and fetch a result set can also be degraded in process 306. As each new time is measured for a particular result set, the average time for the result set can be determined according to the following formulation:

avgTime=avgTime+((newTime−avgTime)/hit)

Where avgTime is the average time to execute and fetch the result set, newTime is the most recent measurement of this time, and hit is the current count of the number of times the result set is requested (the hit count is itself degraded over time). In this formulation, the hit count should not be allowed to go below a value of 1. This could happen if the count were degraded between when the hit count is incremented and the time is recorded. The effect of degradation will lead to the case that the new time is more relevant the more that degradation has occurred. This is the desired behavior as it will bias the average towards the more recently recorded times.

The cache-worthiness data collected in process 304 and degraded in process 306 is used by process 308 to determine a cache-worthiness value for each result set and to recalculate the contents of RS cache 106 based on these values. According to a first example embodiment of the present invention, the following formulation can be used to determine a result set cache-worthiness value:

cache-worthiness value=(hit/invalid+1)※time

Where hit is the number of times the result set is requested, invalid is the number of times the result is invalidated, and time is the average time required to execute and fetch the result set from database 104. These values are degraded over time by process 306. Only those database requests that are satisfied by the database are included in the average time since database requests satisfied by result sets in the cache will be faster. However, the hit count is incremented each time it is determined that a database request can be handled by the cache, regardless of where the result set is obtained.

The cache contents can be recalculated intermittently or on an as-needed basis. Initially, all result sets that are completely fetched are cached until there is no longer sufficient room in RS cache 106. Result sets that are not completely fetched are not cached. For example, clients might only obtain a portion of the data that is requested, say the first 10 records matching a query, even if more is available. RS cache 106 can either ignore these partial fetches or can fetch the entire result set.

At this point, RS cache 106 determines which result sets should be cached and which should be dropped based on the cache-worthiness of the result sets. From that point forward, cache updates can be triggered by different events.

Whenever a result set is fully fetched, it is a candidate for being cached. The problem of selecting one or more result sets from a number of candidate sets is analogous to the “knapsack problem” that is well known to those of skill in the relevant art. The result is a set of result sets to be cached. Some may already be in cache, in which case nothing needs to be done. Others may need to be removed from the cache, while yet others may need to be added. The replacement of victim result set caches is discussed below.

The timing of the degradation 306 process can affect when the recalculate 308 process should occur. The timing of these two processes can be linked, such that any degradation would cause a recalculation of the cache contents to occur and potentially a change in the contents. For example, both degradation 306 and recalculate 308 can be executed for each database request. The effectiveness of this approach depends upon the recalculate 308 process being computationally inexpensive and fast. Alternatively, degradation 306 and recalculate 308 could be executed only after a cache miss. This alternative approach is consistent with the notion that it makes sense to recalculate the cache upon a cache miss but not after a cache hit since only a miss could change what should be in the cache. However, executing these processes on cache misses rather than on every request can result in one unintended consequence. If a result set is removed from the cache as the result of a degradation and cache miss, the result set might be requested again before actually being replaced. This subsequent request might cause the cache-worthiness score of the result set to increase enough such that the result set should not actually be replaced. This situation can be avoided by handling a request for a result set marked as pending removal like a cache miss, triggering the degradation 306 and recalculate 308 processes.

The degradation 306 and recalculate 308 processes can alternatively be executed on an intermittent basis, with the same or different timing. This timed approach has the advantage of de-coupling the calculations associated with these processes from request handling, which is particularly beneficial where any of these calculations require significant processing overhead.

When the recalculate process 308 determines that a certain result set is no longer desirable to have in cache, that result set can be marked as pending removal but not actually removed until one or more new result sets have been fully fetched to take the place of the marked result set. This allows RS cache 106 to respond to any requests for the marked result set that might arrive prior to the arrival of the new result set(s). This approach can be used any degradation and recalculation approach, but it is more relevant with timed degradation and recalculation as there can be a significant delay before a new candidate result set is generated. Even with degradation and recalculation occurring with cache misses, such an approach can be useful. Situations can occur where an entire result set is not fetched, or the fetch might take a significantly long time. In either case, not removing the victim result set(s) until actually necessary could mean that additional request are handled by the cache.

For those instances where a recalculation 308 causes a high turnover in cache contents, an algorithm should be used to remove the fewest victim result sets. Many algorithms are known within the art for making this determination. One simple approach is to sort the potential victims by size then iterate over the victims and select the first victim result set that is larger than the new result set and drop it. If none is larger, then the largest is dropped and the process repeated. Other, more complex algorithms may be used to determine a subset of victims which represent the minimum size required. Such algorithms are well-known in memory management (so call, “best-fit” algorithms). Or, the cache-worthiness score of the victims could be used, wherein those result sets having the lowest cache-worthiness scores are dropped first.

Client-Side, Server-Side, and Appliance Result Set Caches

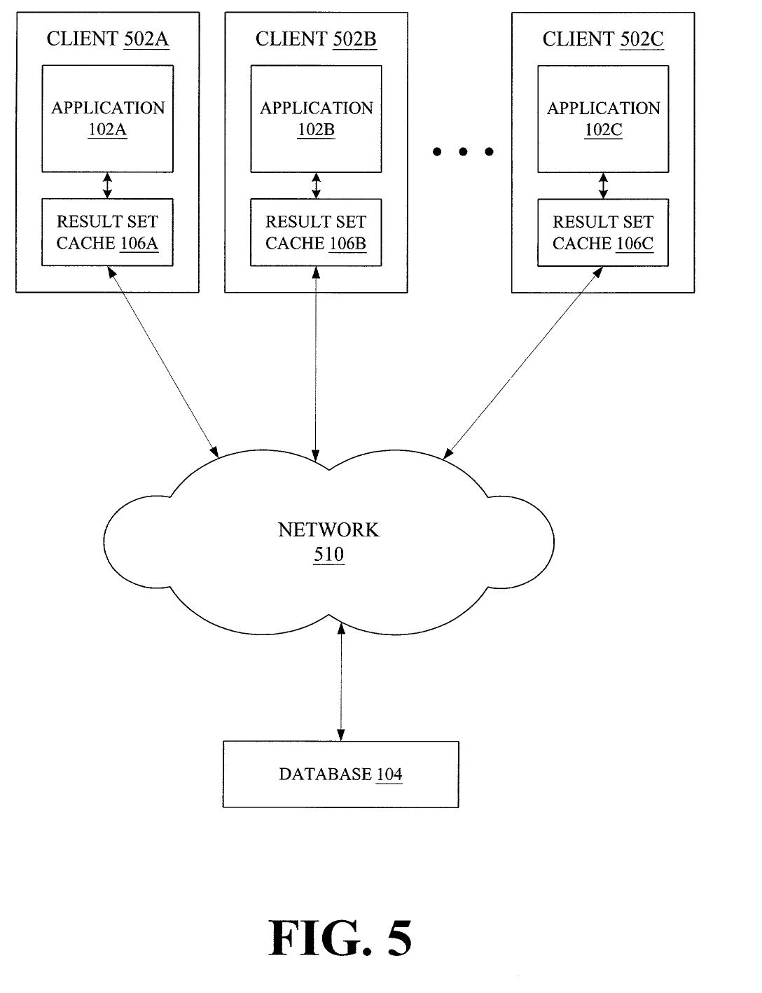

Result set caching can be performed at the client, at the server, or as a stand-alone appliance in communication with the client and server. Or, any combination of these caches could be used, including multiple stand-alone appliances working in a tiered or clustered environment. FIG. 5 depicts a client-side implementation of RS cache 106 according to an example embodiment of the present invention. One or more clients 502 (shown as 502A, 502B, and 502C) host an application 102 (shown as 102A, 102B, and 102C). Client 502 represents the computing resources that host application 102. A result set cache 106 (shown as 106A, 106B, and 106C) is implemented at each client 502. The clients 502 are coupled to a network 510, as is database 104 on the server side.

Client-side result set caching can provide the best performance gain since the result sets need not be passed over network 510 upon a cache hit. However, memory resources might be more limited on client 502 as compared to server-side resources. Furthermore, RS cache 106 might have less control over the available resources than it would server-side. Handling the invalidation of result sets can be more difficult if there are more than one clients 502 contacting database 104. Updates should be reflected in all result set caches 106 if consistency is to be maintained. This requires that a synchronization or refresh capability be implemented amongst the client-side cache as described above.

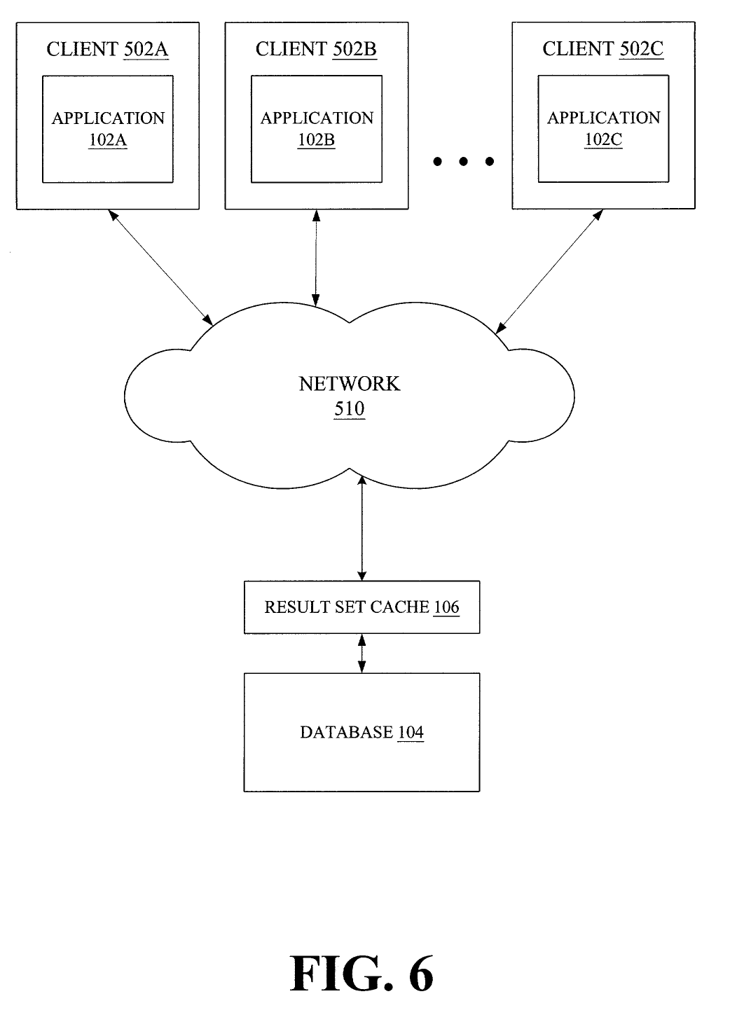

FIG. 6 depicts a server-side implementation of RS cache 106 according to an example embodiment of the present invention. Here, RS cache 106 is implemented on the server-side coupled to database 106 (shown collectively as server 504). RS cache 106 might be integrated at a code level within database 106, or could simply share hardware resources with database 106. Caching at the server requires that the cached result sets be transferred over network 510. However, the processing burdens incurred by database 106 when processing requests are saved when hits are made on the cache. Furthermore, the server-side implementation allows for faster invalidation of stale result sets, particularly if integrated within database 104, and the ability of multiple clients 502 to access the cached result sets.

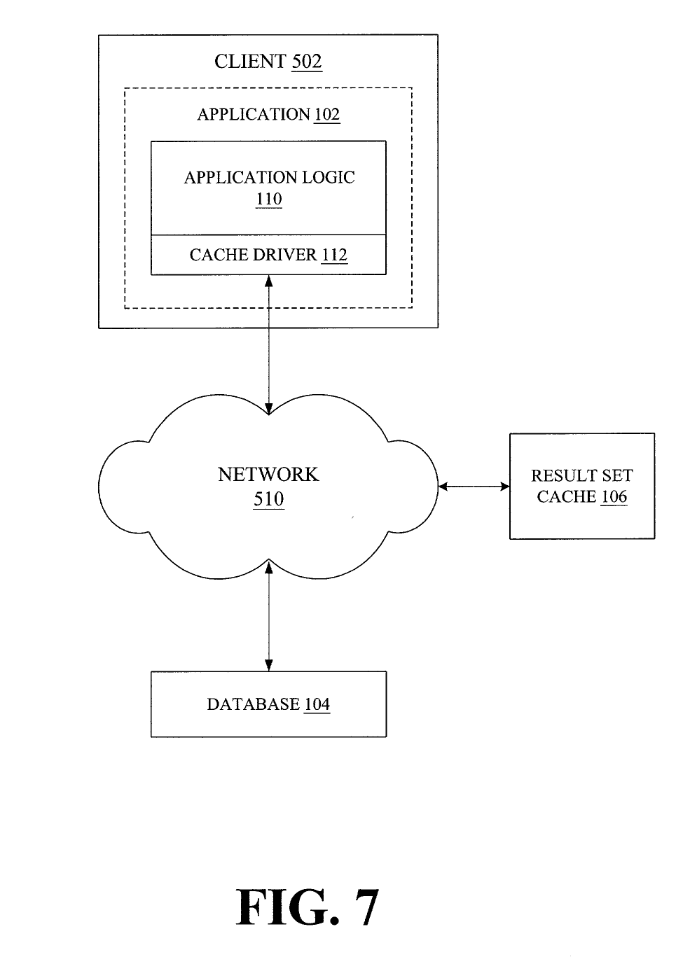

FIG. 7 depicts RS cache 106 implemented as a stand-alone appliance. In this implementation, RS cache 106 has its own dedicated computing resources, and communicates with both clients 502 and database 104 via network 110. Such an implementation does not share hardware resources with any other component, so will have a larger amount of memory available for result set caches. It will also have its own CPU and therefore will not affect the performance of either application 102 or database 104.

Multiple Clients And Databases

In situations where multiple end-users access the same RS cache 106, it may be desirable to prevent a client from accessing data through the cache that they would not be able to access otherwise. For example, if two users execute the same database request, but only one has permission to access the database objects needed to fulfill the request, the other user should not be able to obtain a result set from the cache. One way to accomplish this is to store result sets separately for each client. For example, result sets can be stored with a key equal to a client identifier and the query string from the actual SQL statement. Such an approach might result in data being stored multiple times in cache if multiple clients retrieve the same result sets. Alternatively, the result set cache can restrict each user's access to objects stored within the cache to ensure that unauthorized access is prevented in a manner akin to database 104's access control.

It is also desirable to translate all database requests into canonical form where all database objects are fully qualified before checking to see whether the target result set is in cache. As an example using relational databases, it is possible for two users to have tables with the same unqualified name (that is, the table name without the schema or owner name). Both users could execute the same SQL statement, using unqualified names, and the query would be directed against two different tables in the database. By storing result sets using a key based on the canonical form, this situation can be avoided and the end user will always receive the correct results.

Other similar problems can exist if the database request contains variable information which is translated by the database. For example, the use of the SQL function CURRENT_USER( ) or other similar functions (e.g., Oracle's “user” pseudo-column) causes the same query executed by different users to potentially receive different results. This can be avoided if the variable user information is replaced by the actual user information for the key that is used to store the result set. Date/time functions which obtain the current date are also problematic. A database request which asks for a set of objects modified less than a minute before the current time, for example, could not be cached at all. Examples of such date/time functions are Oracle's “sysdate” pseudo-column or SQL-92's CURRENT_TIME, CURRENT_TIMESTAMP and CURRENT_DATE functions.

Similar issues are raised where a single client-side result set cache 106 supports multiple databases 104. While typically two different vendor databases 104 will not use the same driver, connections to different database instances of the same type may. For example, if there are two Oracle instances running, they will use the same driver, though they will have different URLs or DSNs. A result set cache can support multiple databases, even those which use multiple drivers, as long as it knows which database driver to use. A RS cache that supports multiple databases should, therefore, store results on the basis of a database identifier (such as a URL or DSN), the SQL statement, and potentially the username as described above.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

The previous description of exemplary embodiments is provided to enable any person skilled in the art to make or use the present invention. While the invention has been particularly shown and described with reference to exemplary embodiments thereof, it will be understood by those skilled in the art that various changes in form and details may be made therein without departing from the spirit and scope of the invention.

What is claimed is:

1. A method comprising:
receiving an informational database request; and
determining whether a result set corresponding to said informational database request is stored in a cache, and if so, returning said result set in response to said informational database request, and if not,
sending said informational database request to a database, wherein said database generates said result set, and
determining whether to add said result set to said cache with reference to the cache-worthiness of said result set.

2. The method of claim 1, wherein said cache stores one or more result sets and the database requests corresponding to said one or more result sets, and wherein said determining whether said result set is stored in said cache comprises comparing said database request with said database requests stored in said cache.

3. The method of claim 2, wherein said result set is determined to be stored in said cache if said received database request is identical to one of said database requests stored in said cache.

4. The method of claim 2, wherein said database request comprises a parameter and a query string, and wherein said result set is determined to be stored in said cache if said parameter and said query string are identical to the parameter and query string corresponding to one of said database requests stored in said cache.

5. The method of claim 2, wherein said result set is determined to be stored in said cache if said database request is logically the same as one of said database requests stored in said cache.

6. The method of claim 1, further comprising:
receiving a transactional database request, wherein said transactional database request targets one or more objects within said database; and
invalidating one or more result sets stored in said cache that include data from said one or more objects.

7. The method of claim 1, further comprising:
collecting cache-worthiness data for said result set; and
determining a cache-worthiness value with reference to said cache-worthiness data, wherein said cache-worthiness value is reflective of the cache-worthiness of said result set.

8. The method of claim 7, wherein said cache-worthiness data includes data that is reflective of a number of times said result set has been returned in response to informational database requests.

9. The method of claim 8, wherein said cache-worthiness data further includes data that is reflective of the size of said result set.

10. The method of claim 9, wherein said cache-worthiness data further includes data that is reflective of the amount of time required for said database to generate said result set.

11. The method of claim 10, wherein said cache-worthiness data further includes data that is reflective of the number of times said result set has been invalidated.

12. The method of claim 10, further comprising degrading said cache-worthiness data.

13. The method of claim 12, wherein said degrading comprises degrading said cache-worthiness data on a timed basis.

14. The method of claim 12, wherein said degrading comprises degrading said cache-worthiness data responsive to a miss on said cache.

15. The method of claim 7, wherein said cache-worthiness data includes time data that is reflective of the average time to execute and fetch said result set, and wherein said method further comprises degrading said time data according to
avgTime=avgTime+((newTime−avgTime)/hit)
Wherein avgTime is an average time to execute and fetch said result set, newTime is the most recent measurement of the time to execute and fetch said result set, and hit is the current count of the number of times said result set is requested.

16. The method of claim 7, wherein said cache-worthiness value is determined according to:
cache-worthiness value=(hit/invalid+1)※time
Wherein hit is the number of times said result set is requested, invalid is the number of times the result set is invalidated, and time is the average time required to execute and fetch said result set.

17. A result set cache comprising:
first program code means to receive an informational database request; and
second program code means to determine whether a result set corresponding to said informational database request is stored in the result set cache, and if so, to return said result set in response to said informational database request, and if not,
to send said informational database request to a database, wherein said database generates said result set, and
to determine whether to add said result set to the result set cache with reference to the cache-worthiness of said result set.

18. The result set cache of claim 17, further comprising a memory to stores one or more result sets and the database requests corresponding to said one or more result sets, and wherein said second program code means comprises program code means to compare said database request with said database requests stored in said cache.

19. The result set cache of claim 18, wherein said result set is determined to be stored in said cache if said database request is identical to one of said database requests stored in said cache.

20. The result set cache of claim 18, wherein said database request comprises a parameter and a query string, and wherein said result set is determined to be stored in said cache if said parameter and said query string are identical to the parameter and query string corresponding to one of said database requests stored in said cache.

21. The result set cache of claim 18, wherein said result set is determined to be stored in said cache if said database request is logically the same as one of said database requests stored in said cache.

22. The result set cache of claim 17, further comprising:
third program code means to receive a transactional database request, wherein said transactional database request targets one or more objects within said database; and
fourth program code means to invalidate one or more result sets stored in said cache that include data from said one or more objects.

23. The result set cache of claim 17, further comprising:
fifth program code means to collect cache-worthiness data for said result set; and
sixth program code means to determine a cache-worthiness value with reference to said cache-worthiness data, wherein said cache-worthiness value is reflective of the cache-worthiness of said result set.

24. The result set cache of claim 23, wherein said cache-worthiness data includes data that is reflective of a number of times said result set has been returned in response to informational database requests.

25. The result set cache of claim 24, wherein said cache-worthiness data further includes data that is reflective of the size of said result set.

26. The result set cache of claim 25, wherein said cache-worthiness data further includes data that is reflective of the amount of time required for said database to generate said result set.

27. The result set cache of claim 26, wherein said cache-worthiness data further includes data that is reflective of the number of times said result set has been invalidated.

28. The result set cache of claim 17, further comprising seventh program code means to degrade said cache-worthiness data.

29. The result set cache of claim 28, wherein said seventh program code means executes on a timed basis.

30. The result set cache of claim 28, wherein said seventh program code means executes responsive to a miss on the result set cache cache.

31. A result set cache comprising:
memory to store one or more result sets and metadata associated with each of said result sets;
first program code means to collect cache-worthiness data associated with said one or more result sets;
second program code means to determine a cache-worthiness value for each of said one or more result sets, wherein said cache-worthiness values are determined with reference to said cache-worthiness data; and
third program code means to update the contents of the result set cache based at least in part on said cache-worthiness values.

32. The result set cache of claim 31, wherein said third program code means updates the contents of the result set cache on a timed basis.

33. The result set cache of claim 31, wherein said third program code means updates the contents of the result set cache on an as-needed basis.

34. The result set cache of claim 31, wherein said one or more result sets comprise result sets that have been completely fetched.

35. The result set cache of claim 31, wherein said third program code means uses a cache victimization strategy to update the contents of the result set cache.

36. The result set cache of claim 31, further comprising fourth program code means to degrade said cache-worthiness data.

37. The result set cache of claim 36, wherein said third program code means updates the contents of the result cache responsive to said fourth program code means degrading said cache-worthiness data.

38. The result set cache of claim 36, wherein said third program code means and said fourth program code means are executed responsive to a database request being received by the result set cache.

39. The result set cache of claim 36, wherein said third program code means and said fourth program code means are executed responsive to a miss on the result set cache.

40. The result set cache of claim 36, wherein said third program code means and said fourth program code means are executed on a timed basis.

41. The result set cache of claim 31, further comprising fifth program code means to remove result sets stored in said memory responsive to said third program code means.

42. The result set cache of claim 41, wherein said fifth program code means uses a best-fit algorithm to remove result sets stored in said memory.

43. A system comprising:
a database;
an application;
a result set cache including:
first program code means to receive an informational database request from said application; and
second program code means to determine whether a result set corresponding to said informational database request is stored in said result set cache, and if so, to return said result set to said application in response to said informational database request, and if not,
to send said informational database request to said database, wherein said database generates said result set, and
to determine whether to add said result set to said result set cache based at least in part on the cache-worthiness of said result set.

44. The system of claim 43, further comprising a cache driver, wherein said application calls said cache driver to send said informational database request to said result set cache.

45. The system of claim 44, further comprising a database driver, wherein said result set cache calls said database driver to send said informational database request to said database.

46. The system of claim 43, wherein said application and said result set cache use client-side resources, and wherein said database uses server-side resources.

47. The system of claim 43, wherein said application uses client-side resources, and wherein said result set cache and said database use server-side resources.

48. The system of claim 43, wherein said application uses client-side resources, said database uses server-side resources, and said result set cache comprises a standalone appliance.

49. A system comprising:
a plurality of clients;
a database;
a result set cache configured to store result sets, wherein said result sets are generated by said database in response to database requests issued by said clients, and wherein said result sets are stored separately for each client.

50. The system of claim 49, wherein a key is associated with each of said result sets, and wherein said key is generated with reference to a client identifier and a query string.

51. The system of claim 49, wherein said client identifier comprises actual user information.

52. The system of claim 49, wherein said result set cache restricts access to said result sets such that said clients are only able to access their own separately stored result sets.

53. The system of claim 49, wherein said result set cache comprises first program code means for translating database requests received from said clients into canonical form, wherein a key is associated with each of said result sets, said key being generated in canonical form with reference to a client identifier and a query string.

54. A method of maintaining consistency in a result set cache, wherein said cache stores one or more result sets, said method comprising:
receiving a database request;
determining whether said database request is informational or transactional; and
if said database request is transactional, invalidating result sets stored in the result set cache that include data targeted by said database request.

55. The method of claim 54, wherein each of said result sets is generated based on one or more objects stored in a database, and wherein said invalidating comprises:
parsing said database request to determine whether any of said one or more objects are affected by said database request; and
marking those results sets that were generated based on the affected objects.

56. The method of claim 54, further comprising invalidating result sets stored in the result set cache on a timed basis.
